(19) United States
(12) Patent Application Publication
(10) Pub. No.: US 2007/0163725 A1
(43) Pub. Date: Jul. 19, 2007

(54) Reversible lined drapery

(76) Inventor: Monica Macha, Boise, ID (US)

Correspondence Address: PEDERSEN & COMPANY, PLLC, P.O. BOX 2666, BOISE, ID, 83701, US

(21) Appl. No.: 10/589,316

(22) PCT Filed: Feb. 10, 2005
(86) PCT No.: PCT/US05/04324

§ 371 Date: Aug. 10, 2006

Related U.S. Application Data
(60) Provisional application No. 60/543,807, filed on Feb. 11, 2004.

(51) Int. Cl. A47H 1/00

(52) U.S. Cl. 160/124

(57) ABSTRACT

A reversible drape includes lining with an opening through which the drapery can be inverted so that a first decorative fabric is displayed on one side of the drapery, the lining is displayed on the other side, and the heading of the first decorative fabric is at the top of the drape, while a second decorative fabric preferably is disposed entirely within the drapery body along with the heading of the second decorative fabric. The drapery may be inverted again through the opening in the lining, so that the second decorative fabric is displayed on one side of the drapery, the lining is displayed on the other side, and the heading of the second decorative fabric is at the top of the drape, while the first decorative fabric preferably is disposed entirely within the drapery body along with the heading of the first decorative fabric now at the bottom of the drapery body. This reversibility allows one fabric to be selectively displayed with a second fabric hidden inside the drape and a third fabric preferably always visible on back of the drape regardless of whether the first fabric or the second fabric is showing on the front of the drape. The construction of the drapery allows the raw edges to be hidden regardless of which decorative fabric is shown.

### DESCRIPTION

This application claims priority of provisional U.S. application Ser. No. 60/543,807 filed Feb. 11, 2004, and entitled “Reversible Lined Drapery”, which is incorporated herein by this reference.

### BACKGROUND OF THE INVENTION

1. Field of the Invention

The present invention relates to drapery, and more specifically to reversible drapery. The invention further relates to reversible drapery that is lined.

2. Related Art

Drapes are typically used to cover all or part of a window in a decorative manner. Drapes are typically hung or supported by a rod secured to the window frame or the wall surrounding the window. The upper portion of the drape may be provided with rings or straps that encircle the rod, or the upper portion of the window drape may define a loop or pocket through which the rod is passed.

Drapes usually come in a side variety of colors, fabrics and sizes. Often the homeowner or decorator may choose a particular color or fabric at the time of purchase, however, the homeowner may decide that they want to be able to change the color or fabric depending on the season or to preserve the longevity of the fabric. It is expensive and time consuming to continually purchase and discard window drapes, and therefore, many people are prevented from changing their drapes for the various seasons and/or altering the look of the drapes.

Reversible drapes allow the homeowner or decorator to selectively change the fabric or color of the drapes. However, the problem with most reversible drapes is that they are unlined; one fabric is usually directly disposed behind another fabric in turn exposing one fabric to the window at all times. The fabric facing the window is subject to fading from exposure to sunlight. Therefore, there is still a need for reversible drapery that is also lined in order to protect the fabric from fading due to exposure to sunlight.

Levi (U.S. Pat. No. 3,109,474) discloses a reversible cover for an article of furniture, equipage or accouterment wherein the exposed face or surface of the cover always comprises the finished or display side of a fabric material.

Mole (U.S. Pat. No. 4,020,826) discloses a solar energy system for selectively absorbing or reflecting radiant energy entering through a window of a structure, the system comprising a window drape having a decorative side a and a back side, and a removable liner adjacent the backside of the window drape.

Constance (U.S. Pat. No. 4,391,865) discloses a thermal drapery construction including first and second fabric panels having outwardly facing metalized surfaces, a third panel of high loft, low density, randomly oriented fibers disposed between the first and second panels and a thermal drapery liner located adjacent the metalized surface of the second fabric panel.

Bordenave, Sr. et al. (U.S. Pat. No. 5,251,350) discloses a bedspread comprising a plurality of panels which are each reversible and interchangeable.

Broder (U.S. Pat. No. 5,664,269) discloses a bedding cover including a flap positioned at its center; the flap may be folded to cover one or the other ends of the cover and when it is folded the entire surface of the cover presents a uniform appearance , but of a selected different design or color, etc.

Leaderman et al. (U.S. Pat. No. 5,741,582) discloses a blackout drapery lining having a material or cloth fabric on both external surfaces.

O'Brien (U.S. Pat. No. 5,894,876) discloses a window drape including a face panel and a liner having marginal portions secured to a back side of the face panel and an intramarginal portion carrying plural lengths of shirring tape oriented to extend between top and bottom marginal portions of the liner and a plurality of guide elements arranged in a plurality of rows and columns.

Sapp (U.S. Pat. No. 5,940,909) discloses a reversible pillowcase which is formed by folding a single piece of fabric into substantially three equal portions; the portions are attached together along two sides, thus forming first and second pockets with openings at opposite ends. Inverting the first pocket forms a pillowcase by exposing one decorative surface and inverting the second pocket exposes a second decorative surface.

Burton et al. (U.S. Pat. No. 6,308,648) discloses a liner fabric hemmed separately from a cover fabric; the liner fabric is allowed to drape independently from the cover fabric.

Palmer et al. (U.S. Pat. No. 6,409,264) discloses an interchangeable upholstery cover for the sofa or chair, having an inner and outer surface.

Benavides (U.S. Pat. No. 6,687,931) discloses a cover for a pet cushion for selectively displaying differing surface patterns thereon.

### SUMMARY OF THE INVENTION

The present invention is a reversible drape, and more specifically, a reversible drape comprising at least two decorative fabrics and a liner. Preferably, the back of the drape contains an opening, preferably in the liner, through which the drapery can be inverted so that a first decorative fabric is displayed on one side of the drapery, the liner is displayed on the other side, and the heading of the first decorative fabric is at the top of the drape, while a second decorative fabric is disposed entirely within the drapery body along with the heading of the second decorative fabric. Alternatively, the drapery may be inverted again through the opening, so that the second decorative fabric is displayed on one side of the drapery, the liner is displayed on the other side, and the heading of the second decorative fabric is at the top of the drape, while the first decorative fabric is disposed entirely within the drapery body along with the heading of the first decorative fabric now at the bottom of the drapery body.

The reversibility feature allows one fabric to be selectively displayed with a second fabric hidden inside the drape and a third fabric is always displayed regardless of whether the first fabric or the second fabric is showing. Preferably, the third fabric is a liner to protect the drape from fading due to exposure to sunlight and/or to limit the amount of light penetration into a room. The construction of the drapery allows the raw edges to be hidden regardless of which decorative fabric is shown.

### BRIEF DESCRIPTION OF THE DRAWINGS

FIG. 1A is a front (face) view of one embodiment of a liner fabric.

FIG. 1B is a front (face) view of one embodiment of a first decorative fabric.

FIG. 1B is a front (face) view of one embodiment of a second decorative fabric.

FIG. 2 is a front (face) view of the liner shown in FIG. 1A, wherein the liner has been cut into two sections.

FIG. 3 is a front (face) view of the liner shown in FIGS. 1A and 2, wherein the two sections of the liner are attached using a cooperating hook-and-loop fastener(s).

FIG. 4 is a perspective view of the fabrics shown in FIGS. 1A-1C , wherein the fabrics are stacked in their orientation prior to sewing.

FIG. 5A is a perspective view of one embodiment of the partially sewn drape as the first decorative fabric is being reversed.

FIG. 5B is a perspective view of the embodiment shown in FIG. 5A after the first decorative fabric has been reversed.

FIG. 6A is a perspective view of one embodiment of the partially sewn drape as the first decorative fabric is folded over for sewing the rod pocket and the header.

FIG. 6B is a perspective view of the embodiment shown in FIG. 6A, after the rod pocket and header have been sewn forming the top portion of the drape in its first alternative orientation.

FIG. 7 is a perspective view of one embodiment of the partially sewn drape as the second decorative fabric is being reversed through the opening in the liner.

FIG. 8A is a perspective view of one embodiment of the partially sewn drape as the second decorative fabric is folded over for sewing the rod pocket and the header.

FIG. 8B is a perspective view of the embodiment shown in FIG. 8A, after the rod pocket and header have been sewn forming the top portion of the drape in its second alternative orientation.

FIG. 9A is a side cross sectional view of the finished drape when in the first alternative orientation.

FIG. 9B is a side cross sectional view of the finished drape when in the second alternative orientation.

FIG. 10A is a front view of the finished drape when in the first alternative orientation.

FIG. 10B is a rear view of the embodiment shown in FIG. 10A.

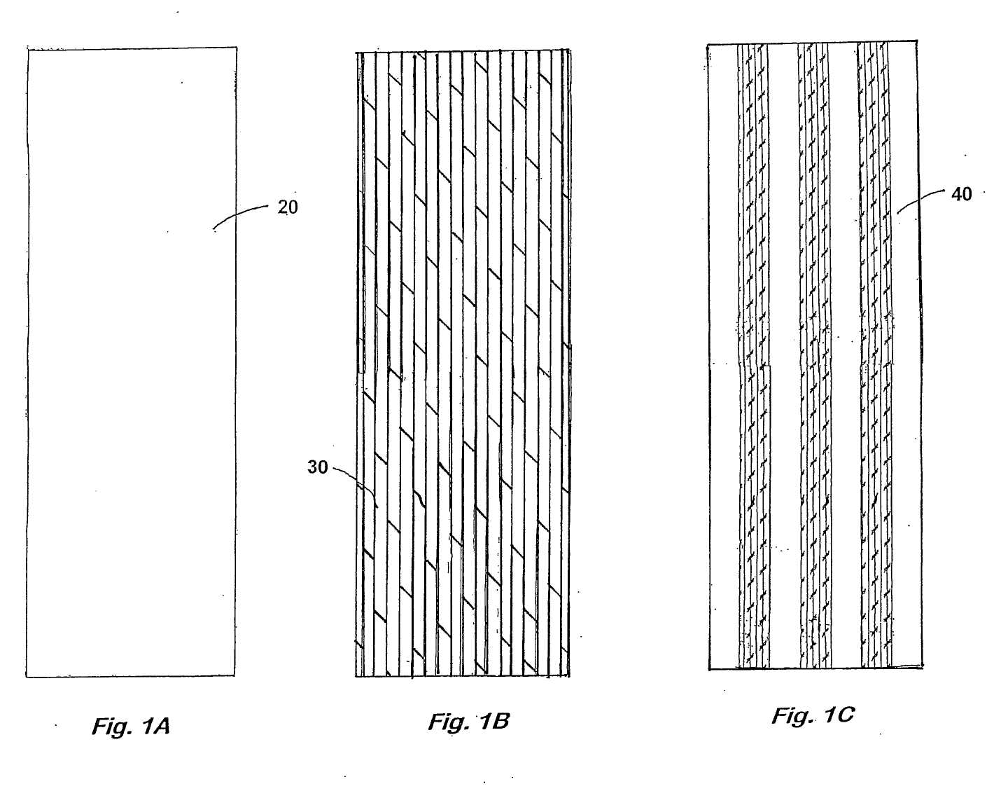

FIG. 1A is a front view of the finished drape when in the second alternative orientation.

FIG. 11B is a rear view of the embodiment shown in FIG. 11A.

FIG. 12 is a front view of two drapes in the second alternative orientation, wherein the drapes are covering a window.

FIG. 13 is a rear view of the embodiment shown in FIG. 12, wherein the drapes are seen from outside a house.

FIG. 14 is a front view of an alternative embodiment of two drapes in the second alternative orientation, wherein the drapes are covering a window, and wherein the heading of the drapes is french pleats.

FIG. 15 is a perspective view of another embodiment of a finished drape with different fabrics, wherein the drape is being reversed from a first alternative orientation to a second alternative orientation.

FIG. 16 is a perspective view of the finished drape of FIG. 15, wherein the drape is being reversed from a second alternative orientation to a first alternative orientation.

### DESCRIPTION OF THE PREFERRED EMBODIMENTS

Referring to the figures, there are shown some, but not the only embodiments of the invented reversible, lined drapery. In the preferred embodiment, a finished drape 10 comprises at least two decorative fabrics 130, 140 and a liner 120. Preferably, the drape 10 comprises an opening 52 in the liner 120 through which the drape can be inverted to display one of the two decorative fabrics 130, 140 while continually displaying the liner 120. While one decorative fabric is being displayed (either 130 or 140) the other decorative fabric is hidden from view within the body of the drape 10 along with its respective heading which may include for example a header (either 132 or 142) and a rod pocket (either 139 or 149) or pleating.

A method of fabricating a window drape 10 in accordance with the present invention is illustrated in FIGS. 1A-8B. While the method steps are described herein as being performed in a particular order using specific dimensions, it will be appreciated that the order in which the steps are performed as well as the dimensions can be varied in accordance with manufacturing considerations and individual preferences. Referring now to FIG. 1A, a liner 20 is shown in its cut size or after being cut from a large sheet of material, for example to a cut width (the width plus allowances for side hems) of about 52″ wide and a cut length (the length plus allowances for hems and seams or headers) of about 157″ long. FIG. 1B shows a first fabric 30 shown in its cut size or after being cut from a large sheet of material, for example to a cut width of about 54″ and to a cut length of about 156″. FIG. 1C shows a second fabric 40 shown in its cut size or after being cut from a large sheet of material, for example to a cut width of about 54″ and to a cut length of about 156″. Preferably, the overall width of the liner 20 is about 2″ shorter than that of the two fabrics 30, 40 to reduce bulk and avoid a ridge.

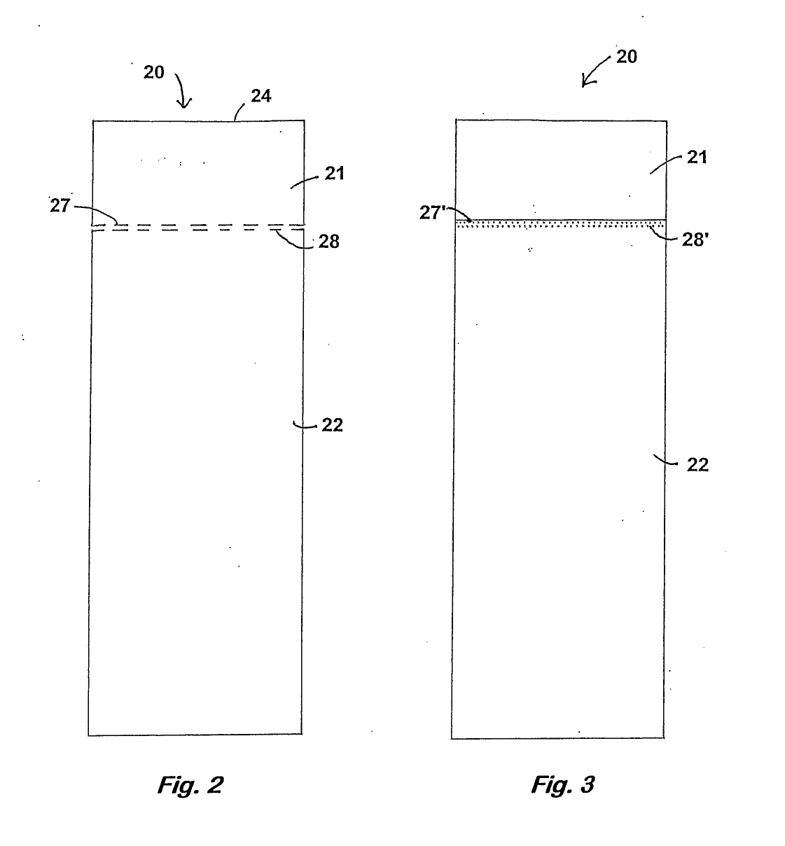

After the fabrics 20, 30, and 40 are cut to their respective sizes, the lining 20 is cut into two sections, an upper section 21 and a lower section 22 (see FIG. 2). The lining 20 is cut about 26″ from the top edge 24, so that the dimensions of the upper section 21 are, for example, about 56″ wide and about 26″ long and the dimensions of the lower section 22 are, for example, about 56″ wide and about 130″ long. Preferably, this creates two “free” edges 27 and 28; these free edges 27, 28 create an opening 52 through which the drapery 10 can be reversed. A cooperating hook strip 28′ and a cooperating loop strip 27′ are preferably cut to be about 0.5″ wide and 56″ long. In the preferred embodiment, the hook strip 28′ is preferably sewn to the free edge 28 of lower section 22 and the loop string 27′ is preferably sewn to the free edge 27 of upper section 21. The inventor envisions, however, that the loop strip 27′ may be attached to the lower section 22 and the hook strip 28′ may be attached to the upper section 21, since the drapery 10 is reversible. After the strips 27′, 28′ are attached to their respective edges, the cooperating fasteners are joined, so that the two lining sections 21, 22 are attached (see FIG. 3). The hook-and-loop fasteners may be Velcro™ or, alternatively, other fasteners may be used such as, buttons, snaps, zippers, small sections of hook-and-loop fasteners, or other mechanisms that allow the free edges 27 and 28 to be releasably opened and closed.

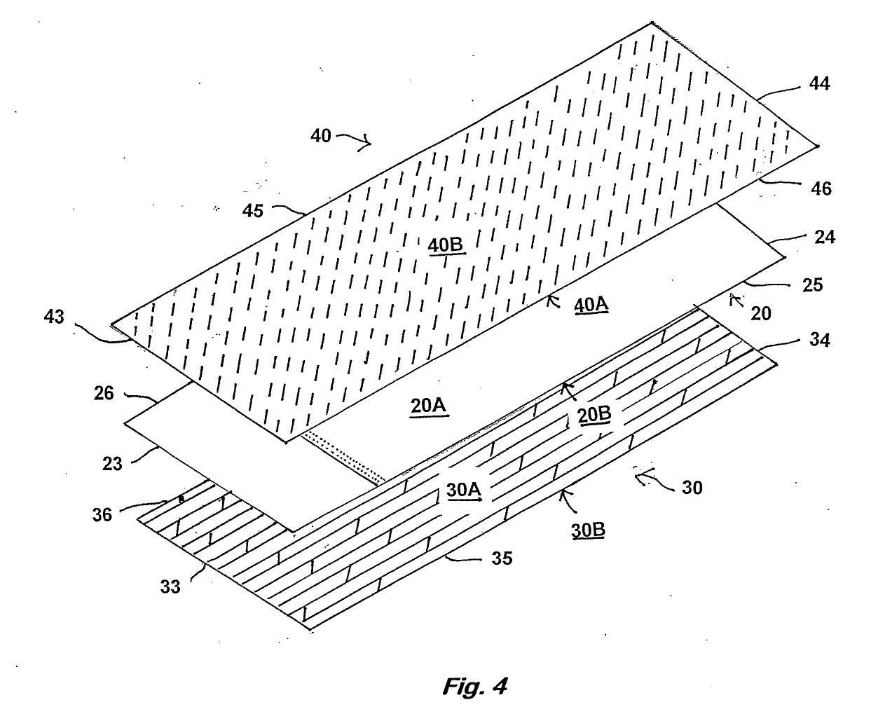

Following the cutting of the lining 20 and the attachment of the fasteners 27′, 28′, the three fabrics 20, 30, and 40 are stacked, as shown in FIG. 4, so that the first fabric 30 is on the bottom with the face or “right” side 30A “up” (the direction “up” in this case is in relation to a floor, table, or other flat surface, so that the face side 30A of the first fabric 30 is not touching the flat surface). The lining 20 is then stacked on top of the first fabric 30; if the lining 20 has a “right” side or face side 20A it is also oriented with the face side 20A “up”, so that the “wrong” side or back side 20B of the lining 20 is touching the face side 30A of the first fabric 30. Finally, the second fabric 40 is stacked on top of the lining 20 with the “right” side or face side 40A facing “down” (the direction “down in this case is in relation to the floor, table, or other flat surface, so that the face side 40A of the second fabric 40 is oriented toward a flat surface). The face side 40A of the second fabric 40 touches the face side 20A (if there is one) of the lining 20. In the preferred embodiment, the fabrics 20, 30, and 40 are stacked so that their side edges 25, 26, 35, 36, 45, 46 are all aligned and the respective top edges 23, 33, 43 and bottom edges 24, 34, 44 are also all aligned (see FIG. 4).

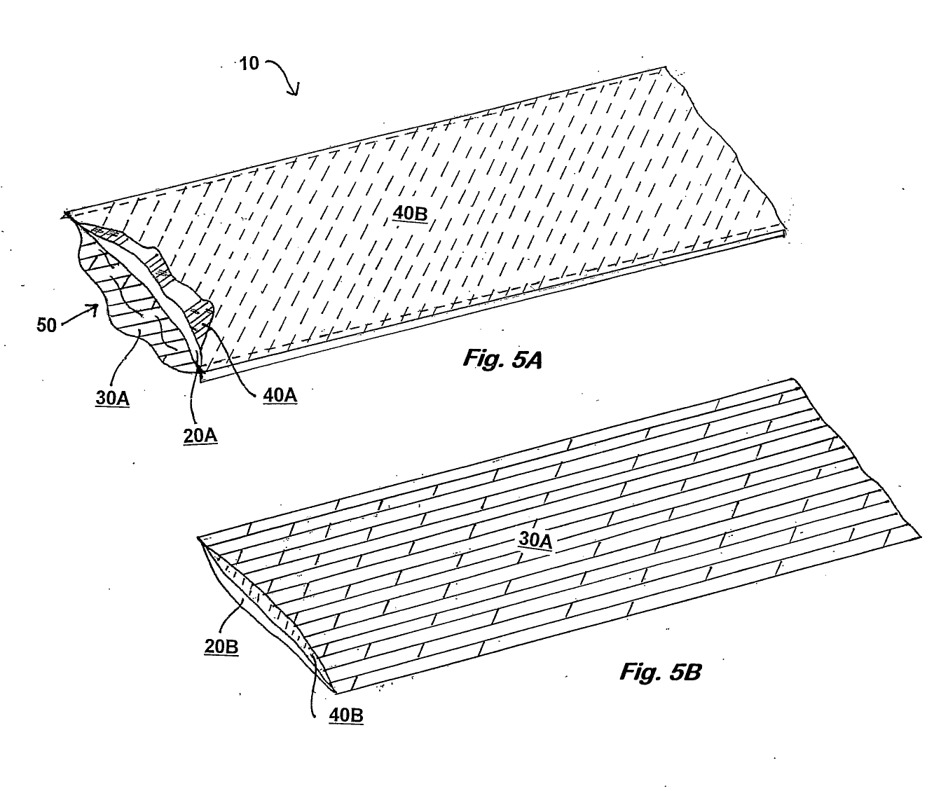

After the fabrics 20, 30, 40 are stacked in their particular orientation, the side edges 25, 26, 35, 36, 45, 46 are sewn, trimmed, and serged; this process is usually done using a serge machine, however, other methods may be used. Preferably, the top edges 23, 33, 43 and the bottom edges 24, 34, 44 are left “open”. As shown in FIG. 5A, the drape 10 is turned inside out by grabbing the first fabric 30 through the opening 50 at the top of the drape 10, so that, when turned inside out, the face side 30A of the first fabric 30 is no longer touching either of the two fabrics 20 or 40 and the liner 20 is no longer in between the two fabrics 30 and 40, but touches only the second fabric 40 (see FIG. 5B). The back side 30B of the first fabric 30 touches the backside 40B of the second fabric and the back side 20B of the liner 20 touches the face side 40A of the second fabric 40. By turning the drape 10 inside out, all of the side raw edges (the cut edge of a piece of garment) are now inside the assembly shown in FIG. 5B and hidden from view.

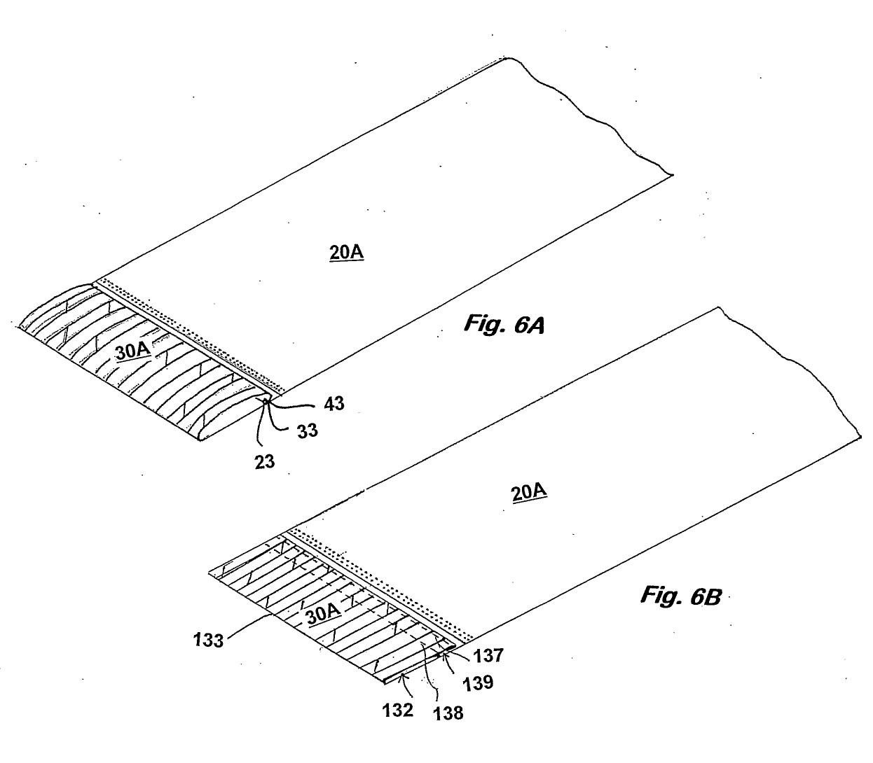

The drape 10 is then oriented so that the face 30A of the first fabric 30 is placed on a flat surface. The top edges 23, 33, and 43 are folded “back”, meaning away from the flat surface and toward the face side 20A of the lining 20, about 9″ (see FIG. 6A). The raw edges of the top edges 23, 33, 43 are turned under and sewn (about 18″ from the original top edges 23, 33, and 43 or about 9″ from the finished top edge 133 when the first fabric 30 is showing) to create a clean finish and form the top portion of the drapery 10 in its first alternative orientation 130. (see FIG. 6B). The first fabric 30 is secured to the face side 20A of the liner 20 and a seam 137 is created for rod pocket 139 placement. A straight line is then sewn across the first fabric 30 about 3.5″ above seam 137 creating a second seam 138 (see FIG. 6B). The opening between the two seams 137 and 138 defines a rod pocket 139 to thread a curtain rod 80 through. The portion of the fabric remaining above the second seam 138 (about 5.5″ of fabric) is the header 132 of the curtain which forms a decorative frill or ruffle. In an alternative embodiment, instead of creating a rod pocket 139 by sewing the second seam 138, the designer may sew triple pleats, pencil pleats, french pleats, pinch pleats, or box pleats using heading tape with cords or other methods known to those in the art (see FIG. 14).

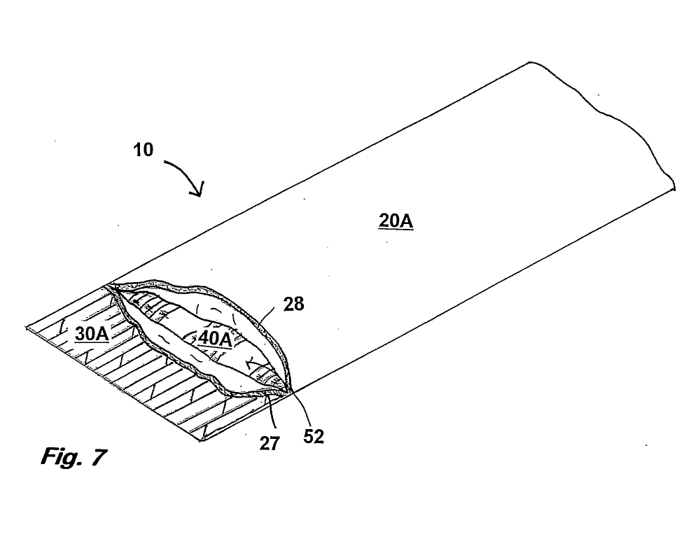

The drapery 10 is then turned inside out again, through the opening 52 created by the free edges 27, 28 of the lining 20, so that the second fabric 40 is pulled through the opening 52 and the first fabric 30 is disposed between the second fabric 40 and the lining 20 (see FIG. 7). Preferably, the back side 40B of the second fabric 40 is touching the back side 30B of the first fabric 30 and the face side 20A of the liner is touching the face side 30A of the first fabric 30. The face side 40A of the second fabric 40 is no longer touching either the first fabric 30 nor the liner 20 and the back side 20B of the liner 20 is no longer touching the first fabric 30 nor the second fabric 40. Again all of the side raw edges are hidden from view.

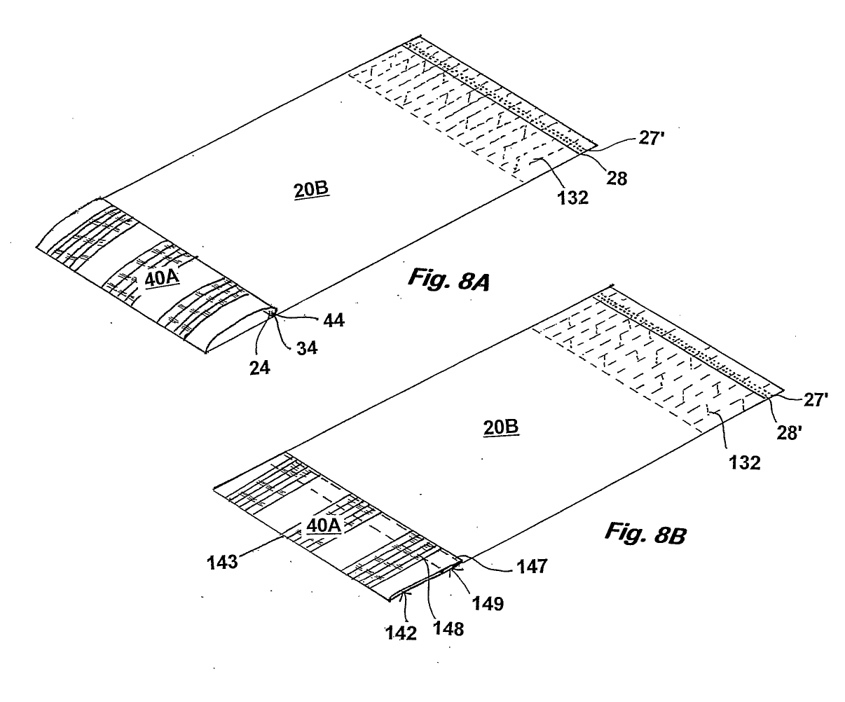

The drape 10 is then oriented so that the face side 40A of the second fabric 40 is placed on a flat surface. The original bottom edges 24, 34, 44 are folded “back”, meaning away from the flat surface and toward the back surface 20B of the lining 20, about 9″ (see FIG. 8A). The raw edges of the bottom edges 24, 34, and 44 are turned under (about 18″ from the original bottom edges 24, 34, and 44 or about 9″ from the finished top edge 143 when the second fabric 40 is showing) to create a clean finish. As shown in FIG. 8B, the original bottom edges 24, 34, and 44, folded over and sewn, forming the top portion of the drapery 10 in its second alternative orientation 140. The second fabric 40 is secured to the back side 20B of the liner 20 and a seam 147 is created for rod pocket 149 placement. A straight line is then sewn across the second fabric 40 about 3.5″ above seam 147 creating a second seam 148 (see also FIG. 8B). The opening between the two seams 147 and 148 defines a rod pocket 149 to thread a curtain rod 80 through. The portion of the fabric remaining above the second seam 148 (about 5.5″ of fabric) is the header 142 of the curtain which forms a decorative frill or ruffle. In an alternative embodiment, instead of creating a rod pocket 149 by sewing the second seam 148, the designer may sew triple pleats, pencil pleats, french pleats, pinch pleats, or box pleats using heading tape with cords or other methods known to those in the art (see FIG. 14).

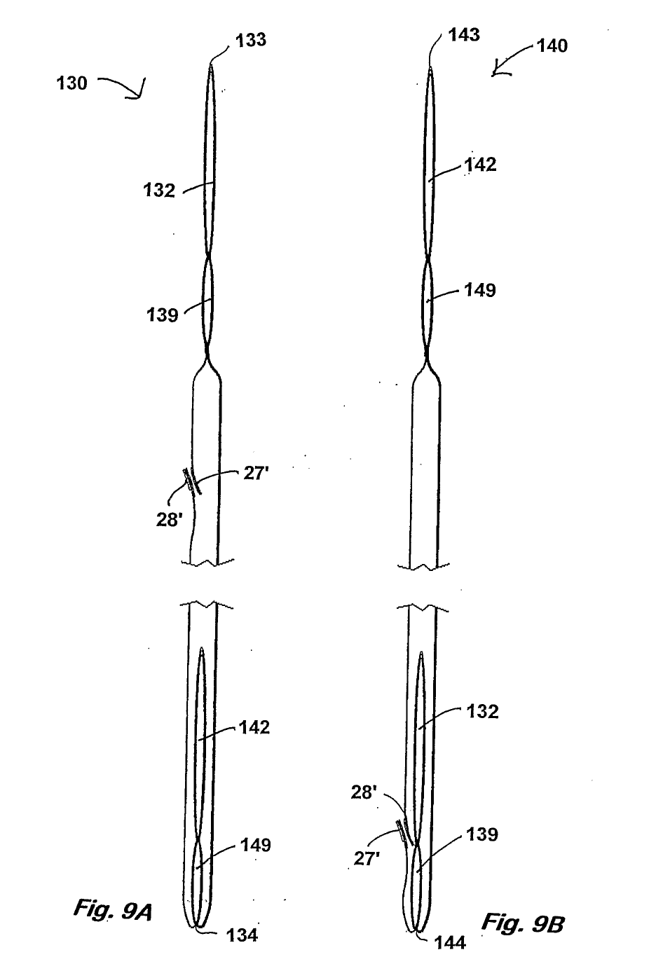

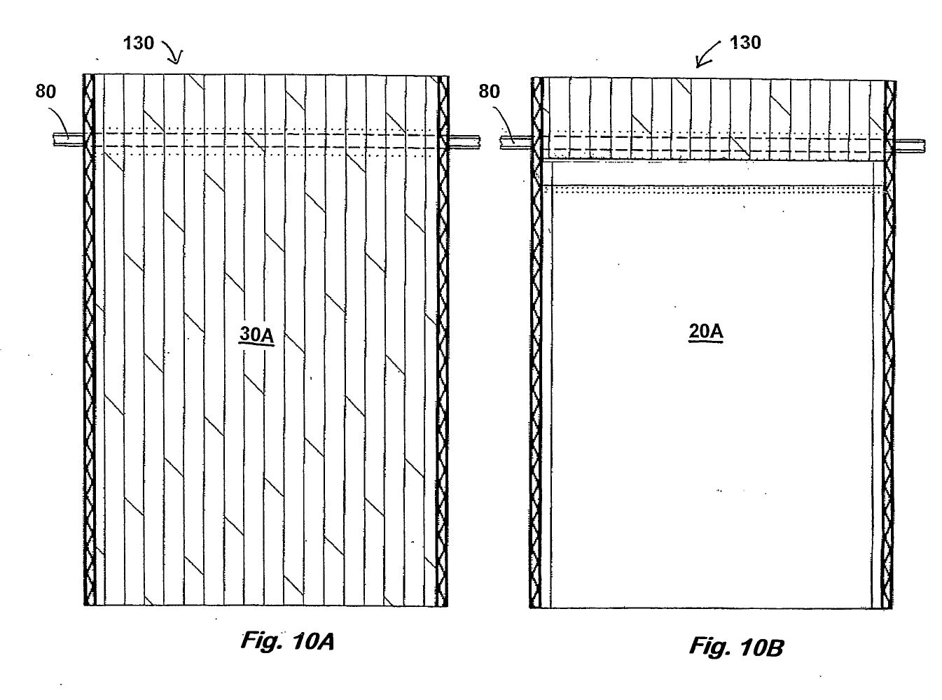

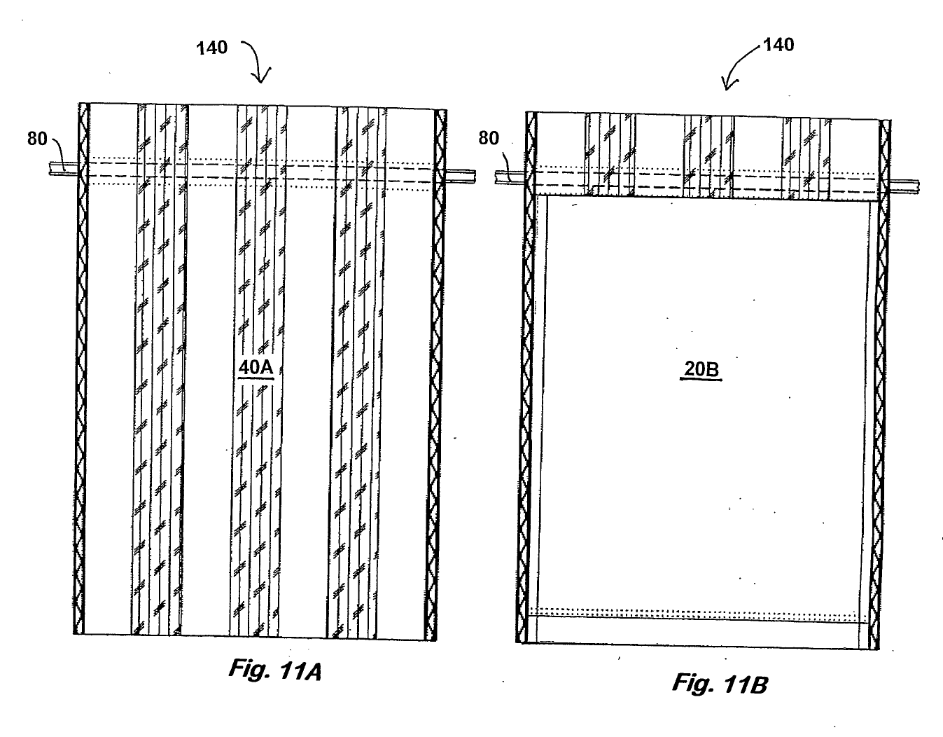

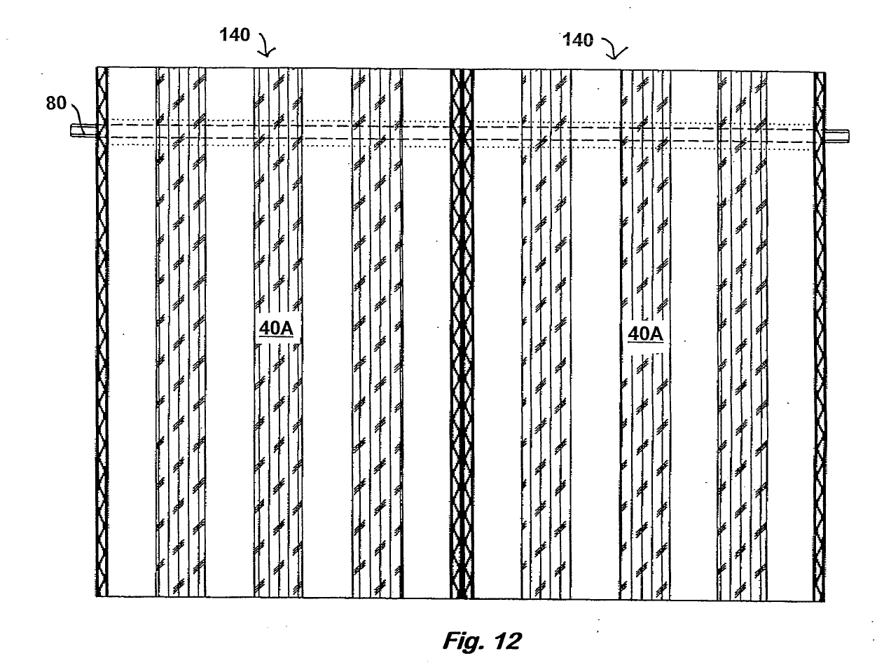

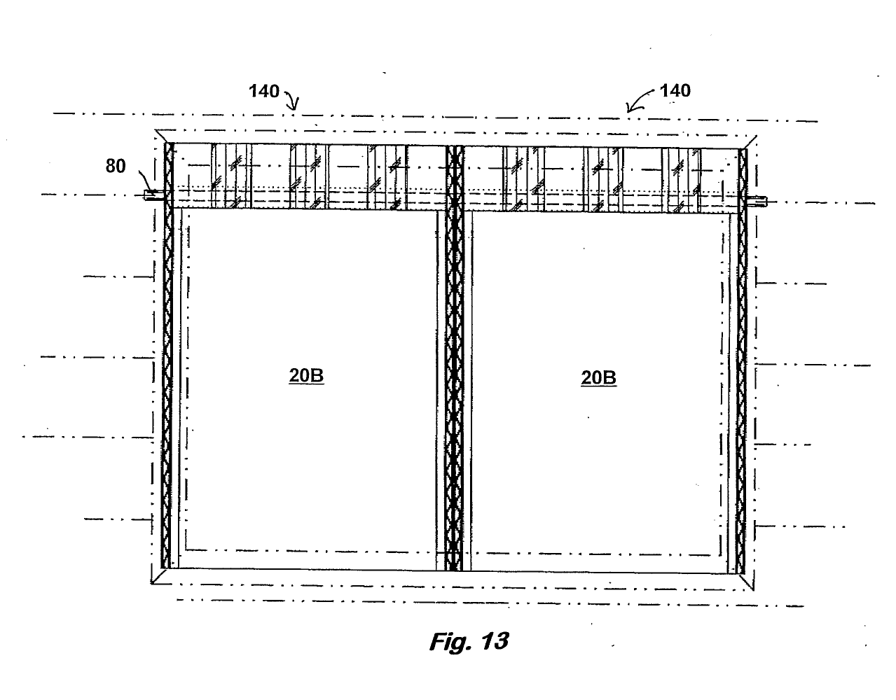

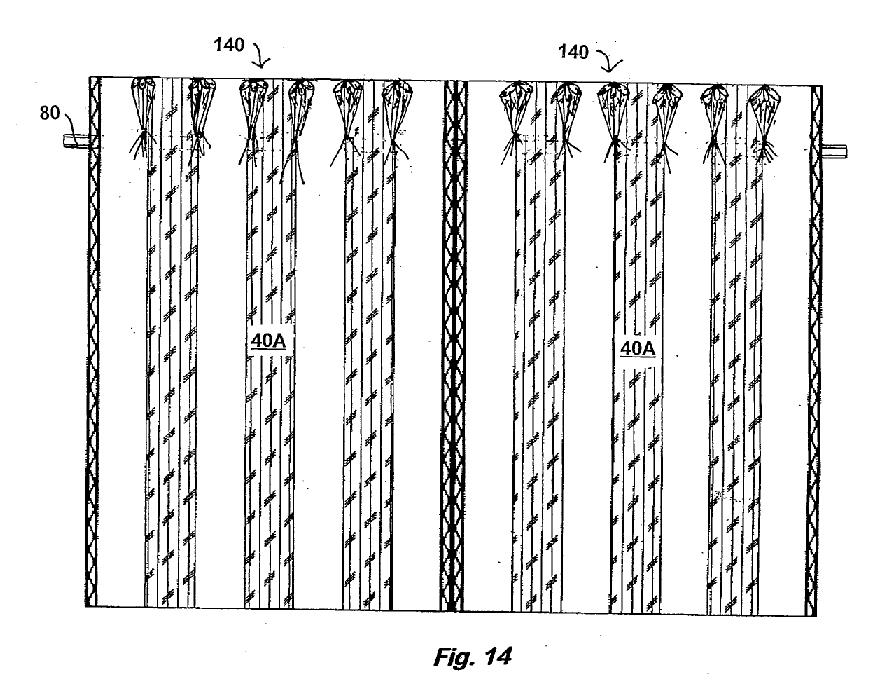

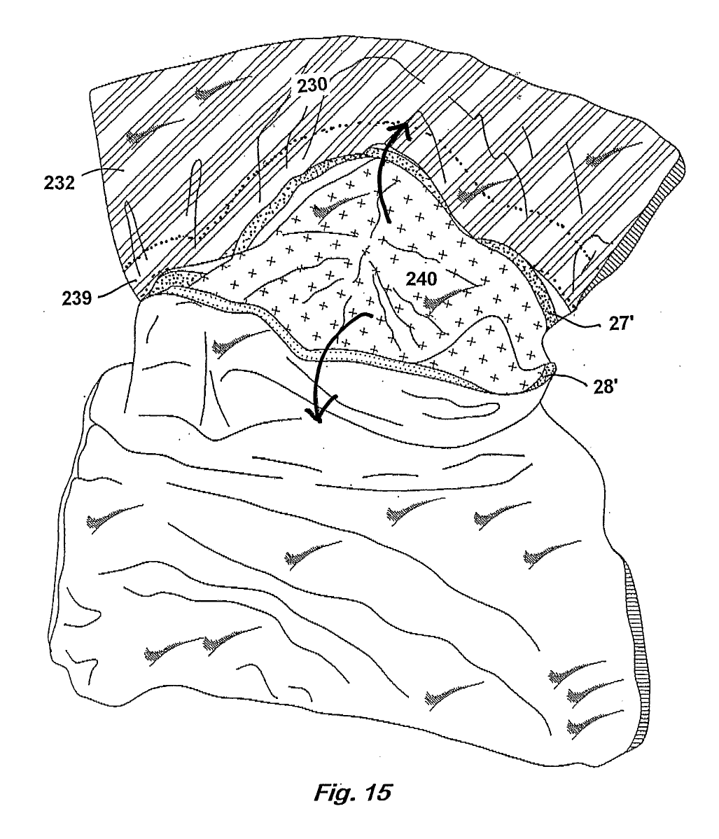

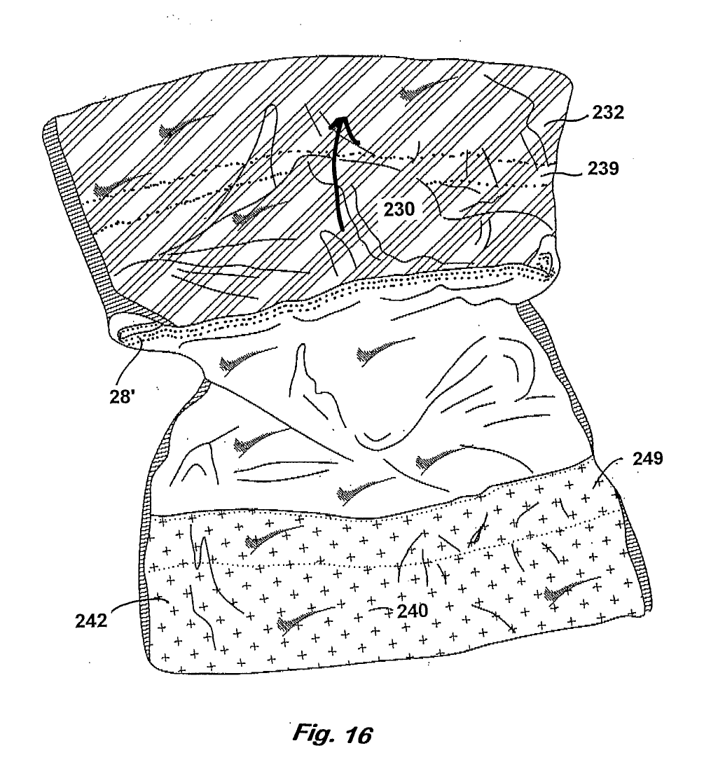

After the drape 10 has been sewn, the drape 10 can be reversed between two alternative orientations 130 and 140. When the drape 10 is in the first alternative orientation 130, the hook-and-loop fasteners 27′, 28′ are positioned near the top of the header 132 and rod pocket 139, and the header 142 and rod pocket 149 of the second alternative orientation 140 are located within the body of the drape 10 (see FIG. 9A). When the drape is in the second alternative orientation 140, the hook-and-loop fasteners 27′, 28′ are positioned near the finished bottom edge 144 of the drape 10 in the second alternative orientation 140, and the header 132 and rod pocket 139 are located within the body of the drape 10 (see FIG. 9B). This construction permits one decorative fabric to be viewed at a time while also allowing it to be protected by a liner. FIGS. 10A-13 illustrate the drape 10 being hung from a curtain rod 80 in either the first alternative orientation 130 or the second alternative orientation 140. The orientation or “view” of the drape 10 can be altered depending on the season or whether the homeowner or designer wants a different “look” for the room in which the drape(s) are hung.

In the preferred embodiment, the first fabric 30 and the second fabric 40 are preferably silk because they are a lighter weight and the drape is less bulky. However, a variety of fabrics may be used, such as cotton, polyester, satin, velvet, suede, etc. Preferably, the liner 20 is a blackout liner to protect the fabric from sunlight and to limit the amount of light that is able to enter the room. Alternatively, the liner may be any UV resistant fabric, or another decorative fabric depending on the desired need of the consumer. Additionally, other fabric patterns may be used to achieve a desired look.

FIGS. 15 and 16 illustrate another embodiment of a finished drape using different decorative fabrics 230 and 240. FIG. 15 illustrates the drape being reversed from the orientation featuring first fabric 230 to the orientation featuring the second fabric 240. In FIG. 15, the fasteners 27′, 28′ have been unfastened from each other to open the opening in the liner (52). In FIG. 15, the second fabric 240 is being pulled out from the opening so that the drape may be turned inside out and the heading for the second fabric 240 may be accessed and used, with the heading (header 232 and rod pocket 239) for the first fabric 230 enclosed within the body of the drape.

FIG. 16 illustrates the drape being reversed from the orientation featuring the second fabric 240 to the orientation featuring the first fabric 230. In FIG. 16, the fasteners 27′, 28′ are again opened (with only 28′ showing in the view of FIG. 16), and the heading (header 232 and rod pocket 239) for the first fabric 230 is being pulled out through the opening in the liner, so that the drape may be turned inside out and the heading (header 242 and rod pocket 249) of the second fabric enclosed within the body of the drape.

The drape(s) may be fitted with tassels, beads, fringe, beaded fringe, rhinestones, braiding, embroidery, rope, and/or tiebacks, or other decorative items to add style. The size of the drape(s) may also be varied in order to cover a specific sized window, or the drape(s) may be manufactured and sold in standard sizes.

Embodiments of the invented reversible drape, therefore, may comprise a drape with a first decorative fabric, a second decorative fabric, and a liner fabric; wherein said drape is reversible to a first orientation wherein said first fabric is visible on a front side of the drape and the liner fabric is visible on a back side of the drape; and wherein said drape is reversible to a second orientation wherein said second fabric is visible on the front side of the drape and the liner fabric is visible on the back side of the drape. A portion of the first decorative fabric may be formed into a first heading adapted to connect to a drapery rod, and a portion of the second decorative fabric may be formed into a second heading adapted to connect to a drapery rod. In the first orientation, the first heading is preferably exposed for connection to the drapery rod and the second heading is preferably enclosed inside an interior space of the drape. In the second orientation, the second heading is preferably exposed for connection to the drapery rod and the first heading is preferably enclosed inside the interior space of the drape. The preferred first heading and the second heading are located on opposite ends of the drape.

As described above, said first fabric and second fabric each have right sides that are preferably visible in the first orientation and the second orientation, respectively, and each have wrong sides that preferably are not visible in the first orientation and not visible in the second orientation. When the first fabric, second fabric, and liner fabric are sewn together at side seams, and raw edges of said side seams are preferably hidden inside said drape between the said wrong sides of the first and second fabrics. The opening through which the drape reverses preferably extends substantially all the way across the drape, but may also be shortened somewhat to help prevent fringe, tassels, or other trim, for example, from getting caught on the hook and loop fastener or from getting caught in between the fasteners. Also, although the opening is shown as substantially nearer one of the headings than the other, alternative embodiments may have the opening and its fasteners at any place along the length of the liner fabric, for example, generally midway along the length of the liner fabric. In less preferred methods of making the drape, the opening may even be at an extreme end of the liner, so that the opening is formed between the liner and another portion of the back of the drape (for example, a tab or flap extending from a heading, rather than between two portions of the liner).

Embodiments of the invented drape may be described as comprising a first decorative fabric on a front side of the drape, and a Liner fabric on a back side of the drape, and the drape further having an interior space defined by an interior surface of the drape and an opening into the interior surface, wherein said interior surface may comprise a second decorative fabric and the liner. The drape is preferably reversible through said opening so that the drape is turned inside out to place the second decorative fabric on the front side of the drape, the first decorative fabric in the interior space of the drape defining the interior surface, and the liner fabric remaining on the back side of the drape. As described above, said drape preferably has a first heading at one end of the drape, and a second heading at an opposing end of the drape. The first heading preferably comprises said first decorative fabric and is exposed and connectable to a drapery rod when the drape is reversed to make the first decorative fabric visible on the front side of the drape. The second heading preferably comprises said second decorative fabric and is exposed and connectable to a drapery rod when the drape is reversed to make the second decorative fabric visible on the front side of the drape. When said first decorative fabric, second decorative fabric, and liner fabric are sewn together at left and right side edges, seams with raw edges are formed, wherein said raw edges are hidden inside the drape then the drape is in any of its reversible orientations.

While the preferred embodiments are described as comprising first and second decorative fabrics and a liner fabric, one may see that the invented apparatus and methods are adaptable to include other layers as well, other decorations, and other additions. For example, insulation may be added, although it is not preferred due to the bulk of such materials. The first and second decorative fabrics each may be a single sheet of a single material, or, alternatively, each may be an assembly of several materials sewn or woven together, for example. Although this invention has been described above with reference to particular means, materials and embodiments, it is to be understood that the invention is not limited to these disclosed particulars, but extends instead to all equivalents within the scope of the following claims.

I claim:

1. A reversible drape comprising:
a first decorative fabric, a second decorative fabric, and a liner fabric;
wherein said drape is reversible to a first orientation wherein said first fabric is visible on a front side of the drape and the liner fabric is visible on a back side of the drape; and
wherein said drape is reversible to a second orientation wherein said second fabric is visible on the front side of the drape and the liner fabric is visible on the back side of the drape.

2. The drape of claim 1, wherein a portion of the first decorative fabric is formed into a first heading adapted to connect to a drapery rod, and wherein a portion of the second decorative fabric is formed into a second heading adapted to connect to a drapery rod, and wherein, in the first orientation, the first heading is exposed for connection to the drapery rod and the second heading is enclosed inside an interior space of the drape.

3. The drape of claim 2, wherein, in the second orientation, the second heading is exposed for connection to the drapery rod and the first heading is enclosed inside the interior space of the drape.

4. The drape of claim 3, wherein the first heading and the second heading are located on opposite ends of the drape.

5. The drape of claim 4, wherein the first heading and the second heading each comprise a header and a rod pocket.

6. The drape of claim 4, wherein the first heading and the second heading each comprise pleats.

7. The drape of claim 1, wherein said first fabric and second fabric each have right sides that are visible in the first orientation and the second orientation respectively, and each have wrong sides that are not visible in the first orientation and not visible in the second orientation, and wherein the first fabric, second fabric, and liner fabric are sewn together at side seams, and raw edges of said side seams are hidden inside said drape between the said wrong sides of the first and second fabrics.

8. The drape of claim 1, wherein the drape is reversible into said first orientation and said second orientation through an opening in said liner fabric.

9. The drape of claim 8, wherein the opening extends substantially all the way across the drape.

10. The drape of claim 1, wherein said liner fabric is blackout fabric.

11. The drape of claim 1, wherein said liner fabric is UV-resistant fabric.

12. A reversible drape comprising:
a first decorative fabric on a front side of the drape, and a liner fabric on a back side of the drape, the drape further having an interior space defined by an interior surface of the drape and an opening into the interior surface, wherein said interior surface is a second decorative fabric and the liner fabric;
wherein the drape is reversible through said opening so that the drape is turned inside out to place the second decorative fabric on the front side of the drape, the first decorative fabric in the interior space of the drape defining the interior surface, and the liner fabric remaining on the back side of the drape.

13. The drape of claim 12, wherein said drape has a first heading at one end of the drape, and a second heading at an opposing end of the drape.

14. The drape of claim 13, wherein said first heading comprises said first decorative fabric and is exposed and connectable to a drapery rod when the drape is reversed to make the first decorative fabric visible on the front side of the drape.

15. The drape of claim 13, wherein said second heading comprises said second decorative fabric and is exposed and connectable to a drapery rod when the drape is reversed to make the second decorative fabric visible on the front side of the drape.

16. The drape of claim 12, wherein said first decorative fabric, second decorative fabric, and liner fabric are sewn together at left and right side edges, forming seams with raw edges, and wherein said raw edges are hidden inside the drape when the drape is in any of its reversible orientations.

17. A reversible drape comprising:
a second decorative fabric on a front side of the drape, and a liner fabric on a back side of the drape, the drape further having an interior space defined by an interior surface of the drape and an opening into the interior surface, wherein said interior surface is a first decorative fabric and the liner fabric;
wherein the drape is reversible through said opening so that the drape is turned inside out to place the first decorative fabric on the front side of the drape, the second decorative fabric in the interior space of the drape defining the interior surface, and the liner fabric remaining on the back side of the drape.

18. The drape of claim 17, wherein said drape has a first heading at one end of the drape, and a second heading at an opposing end of the drape.

19. The drape of claim 18, wherein said first heading comprises said first decorative fabric and is exposed and connectable to a drapery rod when the drape is reversed to make the first decorative fabric visible on the front side of the drape.

20. The drape of claim 18, wherein said second heading comprises said second decorative fabric and is exposed and connectable to a drapery rod when the drape is reversed to make the second decorative fabric visible on the front side of the drape.

21. The drape of claim 17, wherein said first decorative fabric, second decorative fabric, and liner fabric are sewn together at left and right side edges, forming seams with raw edges, and wherein said raw edges are hidden inside the drape when the drape is in any of its reversible orientations.

22. A method of making a reversible drape comprising:
providing a first decorative fabric comprising a right side and a wrong side and two side edges;
providing a second decorative fabric comprising a right side and a wrong side and two side edges;
providing a liner fabric comprising a right side and a wrong side, two side edges, and two sections, wherein the two sections are releasably attached;
placing said first decorative fabric in a first position with the right side up;
placing said liner fabric in a second position on top of said first decorative fabric with the right side up, so that said wrong side of the liner is atop said right side of the first decorative fabric;
placing said second decorative fabric in a third position on top of said liner fabric with the right side down, so that said right side of the second decorative fabric is touching said right side of said liner; and
sewing together said first decorative fabric side edges, said second decorative fabric side edges, and said liner side edges.
